(19) United States
(12) Patent Application Publication
(10) Pub. No.: US 2018/0156376 A1
(43) Pub. Date: Jun. 7, 2018

(54) Protection of Flexible Members

(71) Applicant: Baker Hughes, A GE Company, LLC, a Delaware Corporation, Houston, TX (US)

(72) Inventors: Bjørn Erik Seeberg, Oslo (NO); Christian Nomme, Oslo (NO)

(21) Appl. No.: 15/829,700

(22) Filed: Dec. 1, 2017

Related U.S. Application Data
(60) Provisional application No. 62/428,925, filed on Dec. 1, 2016.

(51) Int. Cl. F16L 57/06; G02B 6/44

(52) U.S. Cl. CPC F16L 57/06; H02G 3/0437; G02B 6/4478

(57) ABSTRACT

Methods, systems, and devices are provided for protecting a flexible member, such as a cable, tube, capillary, fiber, and other similar structures. In an exemplary embodiment, a modular device can include multiple modules that are configured to engage a flexible member. Each module can be configured to couple to a flexible member by an interference fit and to removably mate to another module. Once assembled, the modules can allow movement in a particular direction to allow some flexion of a flexible member extending therethrough.

### CROSS-REFERENCE TO RELATED APPLICATIONS

This application claims the benefit of priority of U.S. Provisional Patent Application No. 62/428,925, filed on Dec. 1, 2017, and entitled “Protection of Flexible Members,” the entirety of which is hereby incorporated by reference.

### BACKGROUND

Cables, tubes, capillaries, fibers, and other flexible members can be sensitive to mechanical deformation arising from excess impact, bending, tension, and/or twisting (torsion). Such deformation can cause damage that can impair the function of the flexible member. For example, fiber optic cables, which include bundles of small diameter plastic or glass filaments, can crack or fracture if bent to a certain radius.

Various devices, such as retractable hoses and telescoping structures, have been developed for protecting flexible members. However, such devices may not be suitable in a number of instances.

### SUMMARY

Some previous devices developed for protection of flexible members can require access to a free end of the flexible member to allow the device to be advanced over the flexible member. Achieving this access can require ends of the flexible member to be disconnected from a mounting location, which in certain circumstances may be undesirable. Furthermore, in certain systems, access to the ends of the flexible member can be obstructed, presenting additional challenges. Additionally, some protection devices can require the use of fasteners, which can add to their cost and complexity of installation.

In general, devices, systems, and methods are provided for protecting flexible members, such as cables, tubes, capillaries, fibers, and similar structures.

In one embodiment, a modular device is provided and it can include at least one module. Each module can have a base, a pin portion, a longitudinal channel, and a transverse channel. At least a portion of the base can extend along a longitudinal axis. The pin portion can include a shaft extending along the longitudinal axis from a first end of the base and a protrusion extending along a first transverse axis. The longitudinal channel can extend along the longitudinal axis and through the base and the pin portion. A transverse channel can extend through at least a portion of the base along a second transverse axis that is rotationally offset from the first transverse axis. Each module can be longitudinally divided in two or more segments. In certain embodiments, the two or more segments can be substantially equal. At least a portion of the longitudinal channel of each module can be dimensioned to secure a flexible member positioned therein by an interference fit.

In another embodiment, the at least two segments can include two segments separated along the longitudinal axis such that the protrusion has first and second protrusion segments and the base has first and second base segments.

In another embodiment, each module can include three protrusions and the at least two segments can include three segments separated along the longitudinal axis such that each of the three protrusion has first and second protrusion segments and the base has first and second base segments.

In another embodiment, the at least one module can include a first module and a second module. The pin portion of the first module can be coupled to the base of the second module.

In another embodiment, the shaft of the first module can be dimensioned for receipt within the longitudinal channel of the second module and the protrusion of the first module can be received within the transverse channel of the second module to couple the pin portion of the first module to the base of the second module and provide a hinge joint.

In another embodiment, the first module and the second module are each rotatable relative to one another about the hinge joint.

In another embodiment, the first end of the base of the first module can be substantially convex and a second end of the base, opposite the first end, can be substantially concave such that a gap is formed between the first module and the second module.

In another embodiment, the one gap is dimensioned to limit rotation of the first and second module relative to one another within a predetermined angular range.

In another embodiment, the base of at least one of the first and second modules can include a first portion that extends along the longitudinal axis and a second portion that extends transverse to the first longitudinal axis.

In another embodiment, the base of at least one of the first and second modules can include a flange adjacent to a second end of the base, opposite the pin portion.

In another embodiment, the pin portion and the base of at least one of the first and second modules can be removably mated to one another.

In another embodiment, the pin portion and the base of at least one of the first and second modules can be rotatably mated to one another.

In another embodiment, the base of at least one of the first and second modules can further include a first longitudinally extending portion, a second longitudinally extending portion, and a rotation joint. The first longitudinally extending portion can include the first end of the base coupled to the pin portion. The second longitudinal portion can include the second end of the base opposite the pin portion. The rotation joint can rotationally couple the first and second longitudinally extending portions of the base. The rotation joint can include a disk and an annular chamber. The disk can be coupled to the first longitudinally extending base portion and it can extend outwards from the longitudinal channel. The annular chamber can be formed in the second base portion and it can be dimensioned to receive the disk.

In another embodiment, at least one of the first and second modules can include the base having a branched second end opposite the pin portion.

Methods for protecting a flexible member are provided. In one embodiment, the method can include positioning a flexible member within a longitudinal channel extending through a pin portion and a base of a first module. The longitudinal channel of the first module secures the flexible member to the first module by an interference fit. The method can further include positioning a pin portion of the first module and the flexible member within a longitudinal channel extending through a pin portion and base of a second module to couple the first module and the flexible member to the second module. The longitudinal channel of the second module secures the flexible member to the second module by an interference fit.

In another embodiment, the shaft of the first module can include a shaft received within the longitudinal channel of the second module and a protrusion received within a transverse channel of the second module to provide a hinge joint.

In another embodiment, the method can include rotating the first and second modules about the hinge joint to bend the flexible member coupled to the first and second modules.

In another embodiment, the first and second modules limit rotation about the hinge joint within a predetermined angular range to inhibit bending of the flexible member coupled to the first and second modules to a bending radius less than a predetermined value.

In another embodiment, the pin portion e and the base of at least one of the first and second modules can be removeably and rotatably mated to one another by a rotation joint that rotates about the longitudinal axis.

### DESCRIPTION OF DRAWINGS

These and other features will be more readily understood from the following detailed description taken in conjunction with the accompanying drawings, in which:

FIG. 1 is a perspective view of one exemplary embodiment of a modular device coupled to a flexible member;

FIG. 2A is a perspective view of a module of the modular device of FIG. 1;

FIG. 2B is an exploded view of the module of the FIG. 2A;

FIG. 3A is a perspective, partially exploded view of two modules of the modular device of FIG. 1 decoupled from one another;

FIG. 3B is a perspective view of the two modules of FIG. 3A coupled to one another;

FIG. 4 is a perspective view of the modular device of FIG. 1 having additional modules coupled thereto;

FIG. 5A is a perspective view of a straight module of the modular device of FIG. 4;

FIG. 5B is a partially transparent, perspective view of the straight module of FIG. 5A;

FIG. 5C is a side view of the straight module of FIG. 5A;

FIG. 6 is a perspective view of a bend module of the modular device of FIG. 4;

FIG. 7A is a perspective view of an end module of the modular device of FIG. 4;

FIG. 7B is a partially transparent, perspective view of the end module of FIG. 7A;

FIG. 8A is a perspective view of one exemplary embodiment of an end module for use in a modular device;

FIG. 8B is an exploded, cross-sectional view of the end module of FIG. 8A;

FIG. 8C is a partially transparent, perspective view of the end module of FIG. 8A;

FIG. 9 is an exemplary embodiment of a module including three segments;

FIG. 10 is an exemplary embodiment of a branched module; and

FIG. 11 is a flow diagram illustrating one exemplary embodiment of a method for protecting a flexible member.

It is noted that the drawings are not necessarily to scale. The drawings are intended to depict only typical aspects of the subject matter disclosed herein, and therefore should not be considered as limiting the scope of the disclosure. Those skilled in the art will understand that the systems, devices, and methods specifically described herein and illustrated in the accompanying drawings are non-limiting exemplary embodiments and that the scope of the present invention is defined solely by the claims.

### DETAILED DESCRIPTION

Methods, systems, and devices are provided for protecting a flexible member, such as a cable, tube, capillary, fiber, and similar flexible members. In certain environments, flexible members extending between two components can be vulnerable to external forces, such as excessive stretching, twisting or bending, as well as impact. Accordingly, modular devices are provided for protecting a flexible member along its length or a portion thereof. In one embodiment, a modular device can include several modules that are configured to mate together (e.g., by an interference fit) about a flexible member. The use of modules can allow a modular device to be assembled in a custom configuration and a custom length. The interference fit connection can allow the modular device to be disposed around a flexible member without requiring detachment of the ends of the flexible member. Such a configuration can be advantageous in systems where the ends of the flexible member are inaccessible. The interference fit connection can also allow for easy removal of the modular device from the flexible member if needed.

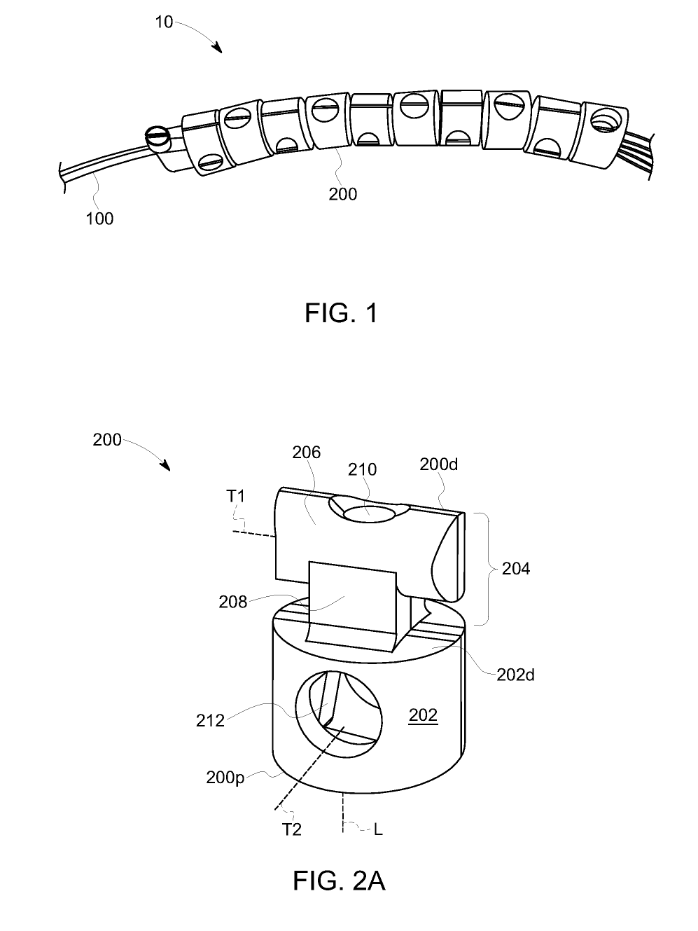

FIG. 1 illustrates one exemplary embodiment of a modular device 10 coupled to a flexible member 100. As shown, the modular device 10 includes multiple modules 200 that enclose at least a portion of the flexible member 100. The length of the modular device 10 can be adjusted by adding or removing modules 200. As discussed in greater detail below, each module 200 can be configured to couple to the flexible member 100 by an interference fit and the modules 200 can removably mate to one another. In other embodiments, the modules can be configured to lock in place to one another and are not removable after being locked in place to one another. Once assembled, each module 200 can be configured to rotate with respect to the adjacent module(s) in a particular direction to allow some flexion of the flexible member 100, as will be discussed in more detail below. The flexible member 100 can be any elongated structure that is solid, hollow, and combinations thereof. Examples of solid flexible members can include, but are not limited to, fibers and cables. Examples of hollow flexible members can include, but are not limited to, tubes and capillaries.

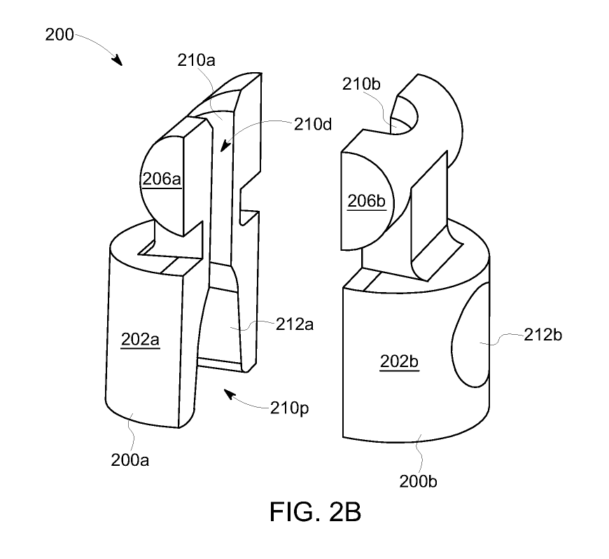

FIGS. 2A-2B illustrate one of the modules 200 of the modular device 10 of FIG. 1 in more detail. While only one module 200 is discussed, each module 200 shown in FIG. 1 can have the same configuration or, in other embodiments, each of the modules can vary. In an exemplary embodiment, the module 200 can have a base 202 adjacent a proximal end 200p and a pin portion 204 adjacent a distal end 200d. The base 202 can extend along a longitudinal axis L. The pin portion 204 can include a shaft 208 extending along the longitudinal axis L from a distal end 202d of the base 202. The pin portion 204 can also include a pin or protrusion 206 extending from the shaft 208 and transverse to the longitudinal axis L along a first transverse axis T1. While the module 200 is illustrated as having a generally cylindrical shape, alternative embodiments of the module can have a variety of other shapes, e.g., oval, square, rectangular, etc.

A plurality of channels can extend through the module 200. As shown in FIG. 2A, a longitudinal channel 210 can extend along the longitudinal axis L of the module 200 between the proximal and distal ends 200p, 200d. A transverse channel 212 can extend through the base 202 along a second transverse axis T2 that is rotationally offset from the first transverse axis T1. In certain exemplary embodiments, the transverse channel 212 can be offset from the transverse axis T1 by 90°. Because the longitudinal channel 210 intersects the transverse channel 212, the transverse channel 212 can be divided into segments extending along the second transverse axis T2, where the first and second transverse axes T1, T2 are substantially perpendicular.

As further shown in FIGS. 2A-2B, the module 200 can be formed into two halves 200a, 200b, allowing the module 200 to be positioned around a flexible member. The protrusion 206, the longitudinal channel 210, and the transverse channel 212 can each be divided along a plane including the longitudinal axis L and first transverse axis T1. The first module half 200a can include a first protrusion segment 206a, a first longitudinal channel segment 210a, and a first base segment 202a. The second module half 200b can include a second protrusion segment 206b, a second longitudinal channel segment 210b, and a second base segment 202b. The first and second protrusion segments 206a, 206b can extend along the first transverse axis T1. The first and second base segments 202a, 202b can extend along the second transverse axis T2. A distal portion 210d of the longitudinal channel 210 can be dimensioned to provide an interference fit connection with the flexible member 100. For example, a diameter of the distal portion 210d of the longitudinal channel 210 can be less than a diameter of the flexible member 100. When the flexible member 100 is positioned between the two halves 200a, 200b of the module 200, the distal portion 210d of the longitudinal channel 210 can deform elastically to accommodate flexible member 100. This elastic deformation can result in friction between the distal portion 210d of longitudinal channel 210 and the flexible member 100 that is sufficient to provide an interference fit coupling the flexible member 100 to the module 200.

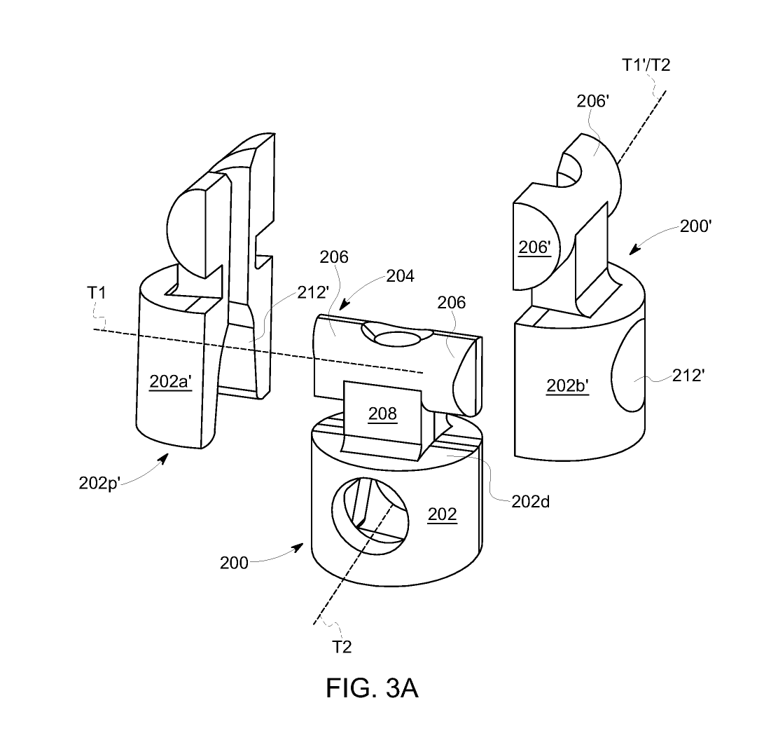

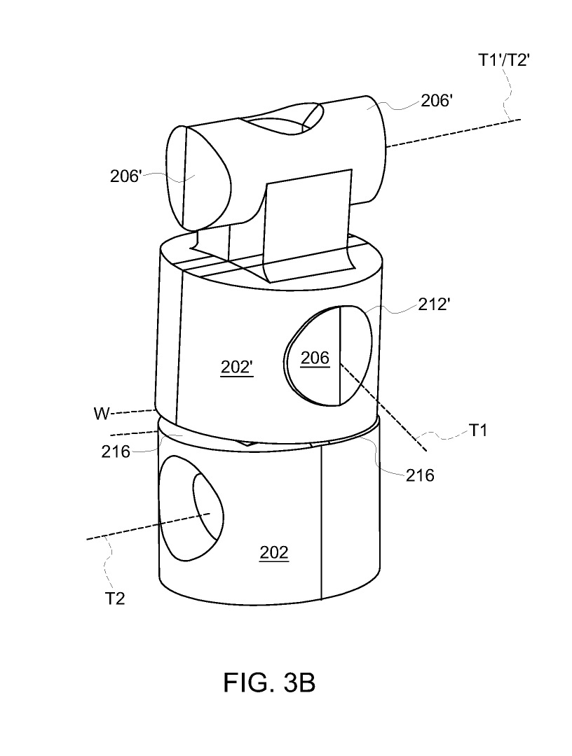

As noted above, each module 200 can also be configured to removably couple to another. FIGS. 3A-3B illustrate first and second modules 200, 200′ that are substantially identical to one another and that are configured to mate to one another. In an exemplary embodiment, a base 202′ of the second module 200′ can be configured to couple to a pin portion 204 of the first module 200. In one aspect, a proximal portion 210p of the longitudinal channel 210 (FIG. 2B) can be dimensioned to receive the shaft 208 of the first module 200. In another aspect, the transverse channel 212′ of the second module 200′ be dimensioned to receive and seat the protrusion 206 of the first module 200.

When the first and second modules 200, 200′ are mated, as shown in FIG. 3B (rotated with respect to FIG. 3A for clarity), they can rotate with respect to one another. In one aspect, positioning the protrusion 206 of the first module 200 within the transverse channel 212′ of the second module 200′ can provide a hinge joint configured to allow rotation about the transverse axis of the hinge joint. As illustrated in FIG. 3B, the first and second transverse axes T1, T2 are substantially perpendicular and an axis of rotation of the hinge joint alternates between the first transverse axis T1 and the second transverse axis T2 along the length of the protection device 10. Coupling the pin portion 204 of the first module 200 to the base 202 of the second module 200′ can provide a hinge joint configured to allow rotation about the first transverse axis T1. Similarly, coupling a base of a third module (not shown) to the hinge of the second module 200′ can provide another hinge joint configured to allow rotation about a first transverse axis T1′ of the second module 200′ (e.g., the second transverse axis T2).

To accommodate rotation of the first and second modules 200, 200′ with respect to one another, a gap 216 can be present between the first and second modules 200, 200′. As shown in FIG. 3B, the gap 216 can extend between at least a portion of a distal facing surface 202d of the base 202 of the first module 200 and a proximal facing surface 202p′ of the base 202′ of the second module 202′. The gap 216 can be present on one side or both sides of the shaft 208 of the first module 200. In one aspect, the gap 216 can be provided by at least a portion of the distal facing surface 202d of the base 202 of the first module 200 having a substantially convex shape. Alternatively or additionally, the gap 216 can be provided by at least a portion of the proximally facing surface 202p′ of the second module 202′ having a substantially concave shape.

Aside from protecting the flexible member 100 from impact by physically surrounding it, embodiments of the modular device 10 can also protect the flexible member 100 from excessive torsion and bending. Torsion can occur by twisting about the longitudinal axis L. The modular device 10 can resist torsion (e.g., provide torsional stiffening) along its entire length due to the rotational offset of the pin portions of respective modules 200. That is, the pin portions 204, 204′ can reinforce the modular device 10 along the first and second transverse axes T1, T2. Furthermore, as discussed above, rotation can be accommodated by the gap 216. Thus, a width W of the gap 216 can be varied in magnitude to limit an amount of rotation of the first module 200 and the second module 200′ relative to one another within a predetermined angular range. In further embodiments, the width W of the gap 216 can be varied in position to inhibit rotation in certain directions and allow rotation in other directions. In this manner, when the flexible member 100 is coupled to the modular device 10, the flexible member 100 can bend and such bending can be limited to a bending radius less than a predetermined value in a predetermined direction.

While FIG. 3B illustrates first and second modules 200, 200′ oriented at an angle of approximately 90° with respect to one another, alternative embodiments of the protection system can include modules configured to couple to one another at different orientation angles to adjust the torsional stiffness. In further embodiments, the geometry of each module 200 and the material from which each module 200 is constructed can vary. For example, the dimensions of the module 200 can be varied based upon the diameter of the flexible member 100. As another example, the material from which the module 200 is formed can be varied based upon a desired level of mechanical protection and/or environmental conditions. In certain exemplary embodiments, the module 200 can be formed from metals or ceramics for use in relatively high stress or aggressive environmental conditions or formed from plastics for use in relatively lower stress or less aggressive environmental conditions. In some instances, more than one module may be connected where one or more modules 200 are formed of different materials.

In use, the modular device 10 can include any number of modules 200 having any configuration mated in a desired arrangement. The modules 200 can be coupled to the flexible member 100 by an interference fit to provide protection to the flexible member 100, while still allowing some movement of the flexible member 100, or portions thereof, as may be desired. Each module 200 can be connected to an adjacent module in a chain-like manner, which may eliminate the need for additional fasteners, and may reduce cost and complexity of the modular device 10.

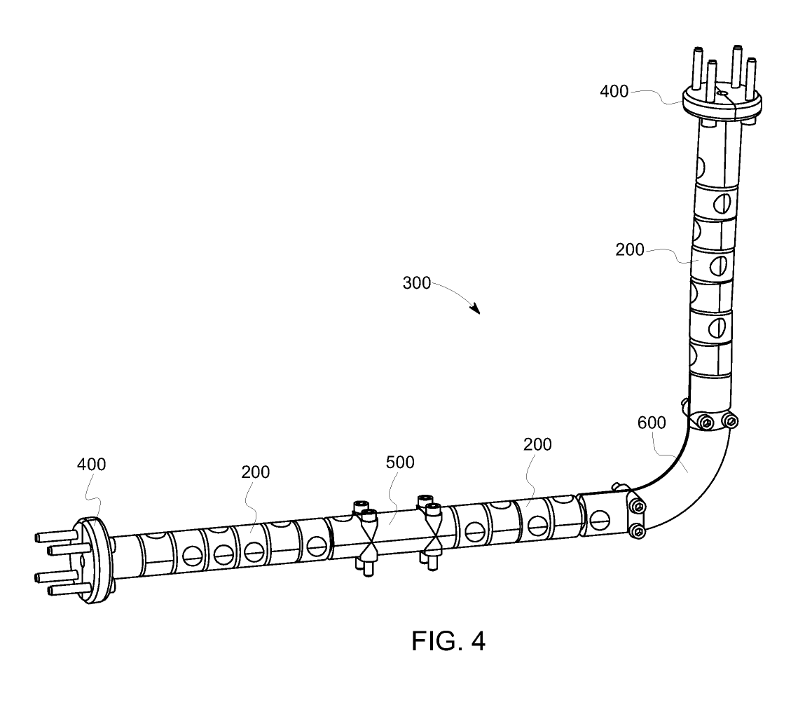

The modular device 10 can also include a variety of additional modules that differ from module 200. As an example, FIG. 4 illustrates a modular device 300 that can include several modules 200 having a configuration as discussed above. As shown, the modules 200 can be coupled to end modules 400 disposed at opposite ends of the assembled modular device 300. The modular device 300 can also include one or more straight modules 500, and one or more bend modules 600.

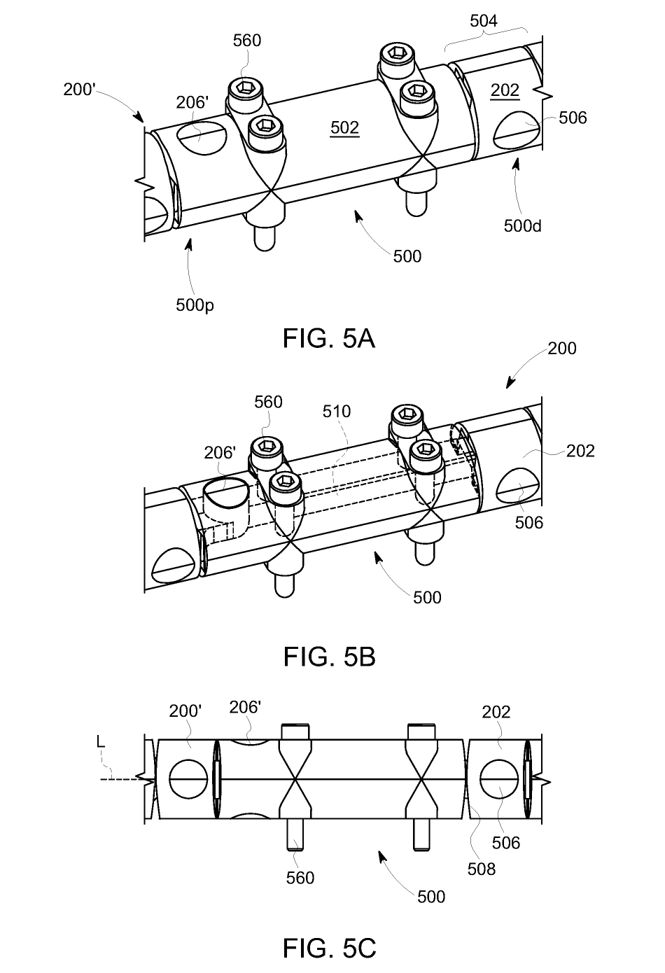

The straight module 500 can have a variety of configurations, but in general, it can be configured to couple at each end to embodiments of any other module discussed herein (e.g., 200, 400, 600, 800, 900, 1000). As illustrated in FIGS. 5A-5C, in one exemplary embodiment, the straight module 500 can be similar to module 200, however it can have a longer length. The straight module 500 can be longitudinally divided into two or more segments and it can include a base 502 adjacent to a proximal end 500p and a pin portion 504 adjacent to a distal end 500d. The base 502 can extend along a longitudinal axis L along its entire length. The pin portion 504 can include a pin or protrusion 506 connected to a shaft 508. A longitudinal channel 510 can extend along the longitudinal axis L and through both the pin portion 504 and the base 502. The straight module 500 can be bifurcated into halves to couple with the flexible member 100 in an interference fit via the longitudinal channel 510. The protrusion 506 of the pin portion 504 of the straight module 500 can be coupled to the base 202 of a first module 200, and the base 502 of the straight module 500 can receive a protrusion 206′ of a pin portion 204′ of a second module 200′, as described above. The straight module 500 can be relatively rigid with respect to modules 200 of comparable length coupled together (e.g., the straight module 500 can inhibit significant bending in any direction along its length). Accordingly, embodiments of the straight module 500 can be mated to a portion of the flexible member 100 where bending is undesired.

As further shown in FIGS. 5A-5B, the straight module 500 can also include one or more securing mechanisms 560 for securing the halves of the straight module 500 to one another. The securing mechanism 560 can be beneficial where a press-fit coupling may be insufficient to maintain attachment of the straight module 500 to the flexible member 100. In an exemplary embodiment, the securing mechanism 560 can be a fastener or bolt that extends through the straight module 500. However, other suitable securing mechanisms can be employed (e.g., adhesives, elastic bands, etc.).

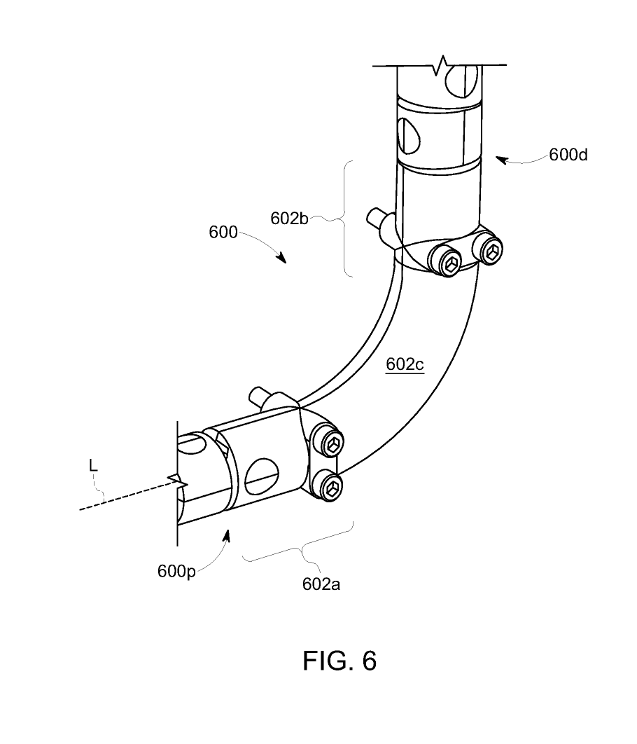

FIG. 6 illustrates the bend module 600 in more detail. While the bend module 600 can have a variety of configurations, in general, it can be configured to couple at each end to embodiments of any other module discussed herein (e.g., 200, 400, 500, 800, 900, 1000) as well as to the flexible member 100. The bend module 600 can be configured substantially the same as the straight module 500 discussed above, however the bend module 600 can be curved or bent along its length. As an example, the bend module 600 can include a base having a first base portion 602a that extends along a longitudinal axis L adjacent to a proximal end 600p of the bend module 600. The base of the bend module 600 can also include a second bend portion 600b that extends transverse to the longitudinal axis L adjacent to a distal end 600d of the bend module 600. In certain embodiments, the second bend portion 600b can extend approximately perpendicular to the first longitudinal axis L. A bend portion 602c of the base of the bend module 600 can have a curved shape extending between the first and second bend portions 602a, 602b. While the bend module 600 illustrated in FIG. 6 is illustrated as bending approximately 90°, alternative embodiments of the bend module can adopt a variety of different angles with any degree of bending or curving at various locations along its length. Alternative embodiments may also include more than two bends.

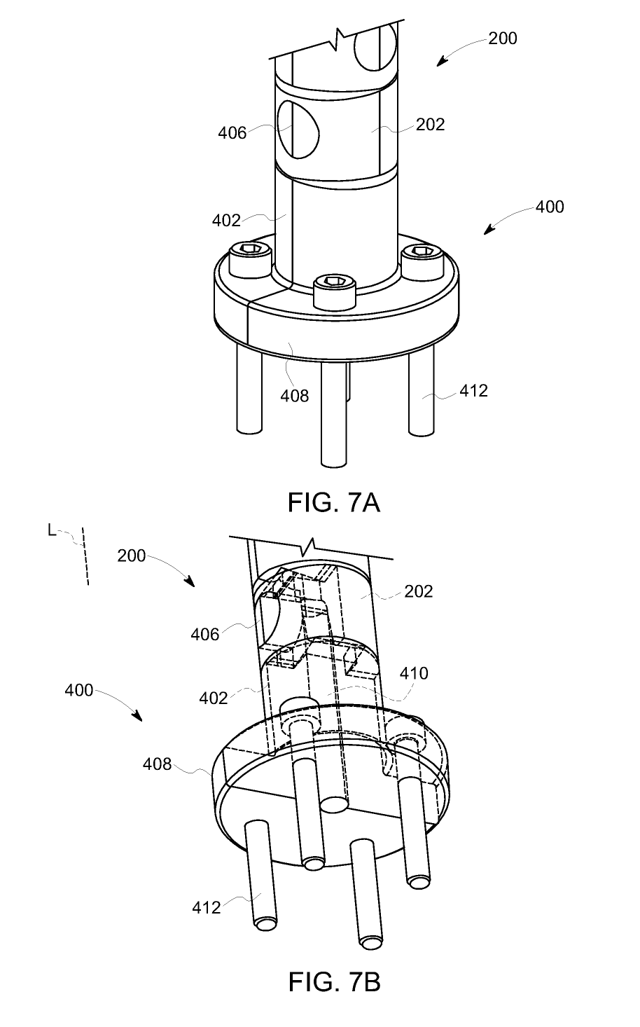

FIGS. 7A-7B illustrate the end module 400 of FIG. 4 in greater detail. The end module 400 can have a variety of configurations, but in general it can be configured to couple at one end to embodiments of any other module discussed herein (e.g., 200, 500, 600, 800, 900, 1000). In one embodiment, the end module 400 can be similar to the module 200, longitudinally divided into two or more segments, and it can include a base 402, a pin portion 404 with protrusion 406, and a longitudinal channel 410 having a configuration similar to base 202, pin portion 204, protrusion 206, and longitudinal channel 210, respectively, as discussed above. As an example, the protrusion 406 can be received within a base 202 of a module 200 to couple the end module 400 to the module 200 and the flexible member 100 can be coupled to the end module 400 within the longitudinal channel 410 by an interference fit.

In contrast to module 200, the end module 400 can replace the transverse channel 212 and the proximal end 200p of the module 200 with a flange 408 including a securing mechanism 412. In an exemplary embodiment, the securing mechanism 412 can be bolts or fasteners that extend through the thickness of the flange 408. In other embodiments, any suitable securing mechanism can be employed (e.g., adhesives, welding, etc.). The end module 400 can further couple with a fixed structure at the proximal end 800p via the securing mechanism 412 extending through the flange 408.

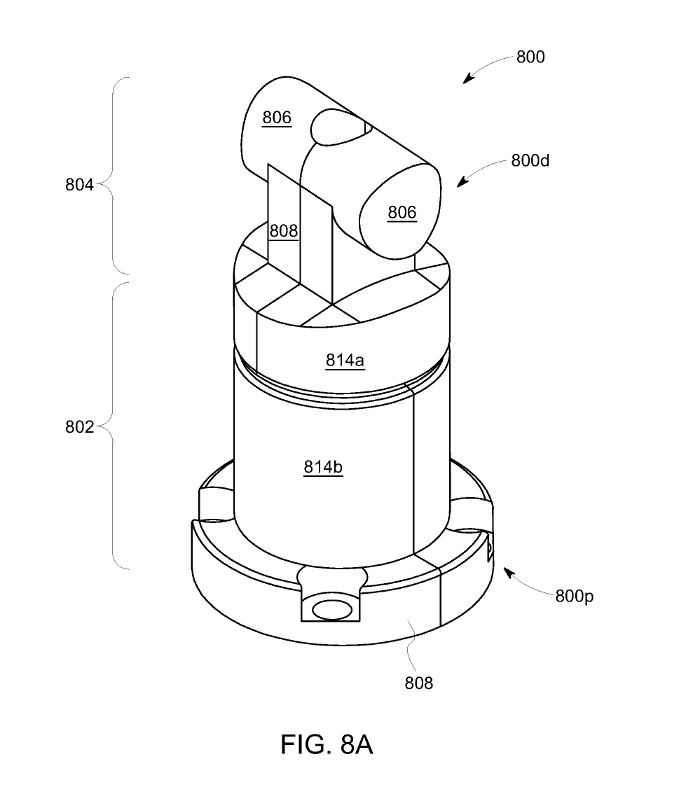

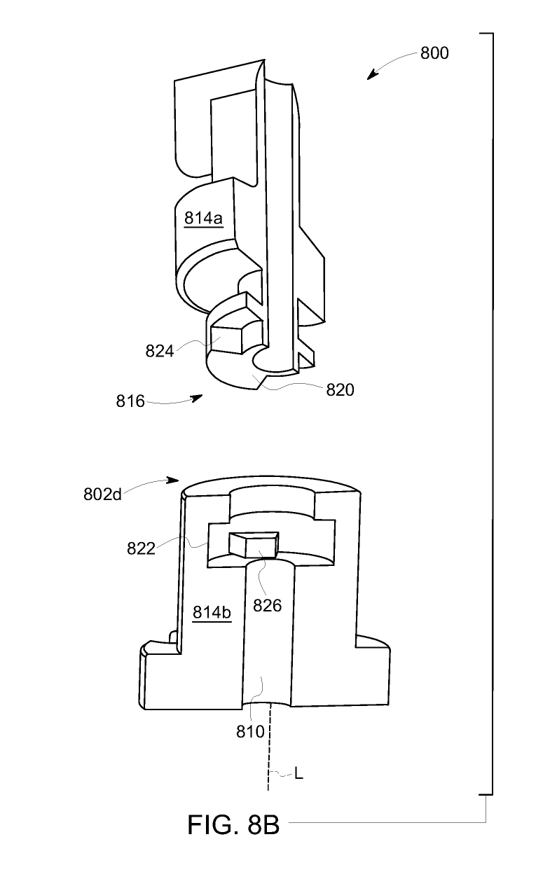

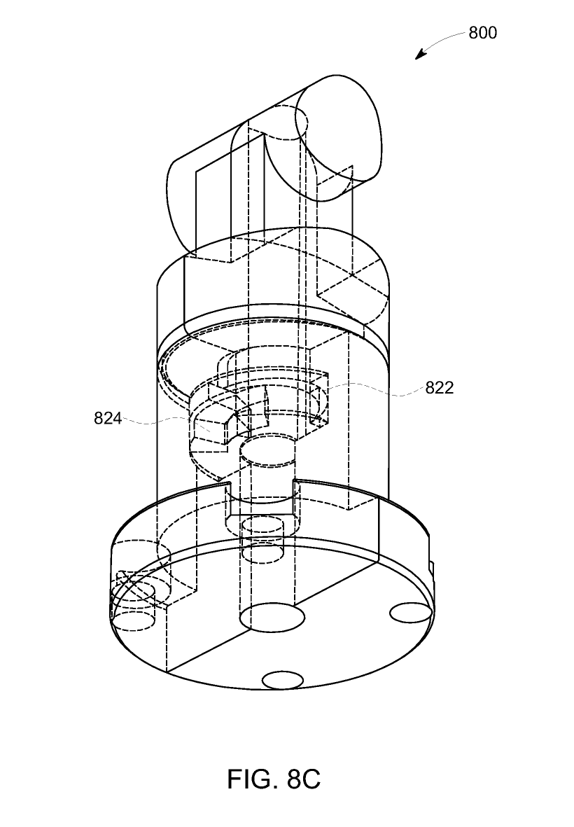

FIGS. 8A-8B illustrate another exemplary embodiment of an end module 800. The end module 800 can have a variety of configurations, but in general, it can be configured to couple at one end to embodiments of any module discussed herein (e.g., 200, 400, 500, 600, 900, 1000). As shown, the end module 800 can be similar to end module 400, longitudinally divided into two or more segments, and it can include a pin portion 804 having protrusion 806 at a distal end 800d, a flange 808 at a proximal end 800p, and a base 802 extending between the pin portion 804 and the flange 808. As an example, the end module 800 can couple with an adjacent module 200 at the distal end 800d via the pin portion 804, where the protrusion 806 can be received within base 202 of module 200 to couple the end module 800 to module 200. The flexible member 100 can be coupled to the end module 800 within the longitudinal channel 810 by an interference fit. The end module 800 can further couple with a fixed structure at the proximal end 800p via a securing mechanism (e.g., bolts, not shown) extending through the flange 808.

The end module 800 can differ from the end module 400 by including a rotation joint that is configured to allow the pin portion 804 to rotate about the longitudinal axis L with respect to a portion of the base 802. As shown in FIGS. 8A-8C, the base 802 can be transversely sectioned into a first base portion 814a and a second base portion 814b. The first base portion 814a can include the distal end 800d of the end module 800 and is can be coupled to the pin portion 804. The second base portion 814b can include the proximal end 800p of the end module 800 and it can be coupled to the flange 808. The rotation joint can include a disk 820 formed adjacent to a proximal facing end 816 of the first base portion 814a and an annular chamber 822 formed within the second base portion 814b. The disk 820 and the annular chamber 822 can each extend transversely about the longitudinal channel 810. The annular chamber 822 can be further dimensioned to receive the disk 820.

The rotation joint can be configured to permit either limited rotation or free rotation of the pin portion 804 with respect to the first portion of the base 802. Limited rotation of the pin portion 804 about the longitudinal axis L can be provided by including a notch 824 in the disk 820 and a mating protrusion 826 in the annular chamber 822. When the first and second base portions 802a, 802b are rotatably coupled to each other by the rotation join, rotation of first base portion 814a and the pin portion 804 with respect to the second base portion 814b can be limited by contact of the protrusion 826 with sidewalls of the notch 824. The notch 824 and the protrusion 826 can be dimensioned to limit rotation of the pin portion 804 within a selected range of non-zero angles less than 360° about the longitudinal axis L. In another embodiment (not shown), free rotation of the pin portion 804 with respect to the base 802 can be provided by omitting the notch 824 and/or the protrusion 826.

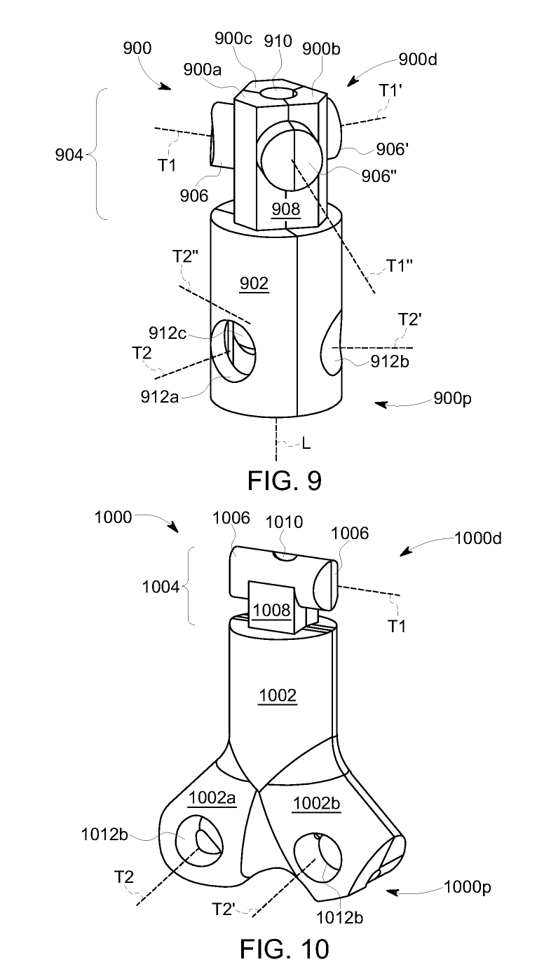

Further embodiments of the module can include more than two segments. As an example, FIG. 9 illustrates a module 900 formed into three segments 900a, 900b, 900c. The module 900 can include a generally cylindrical base 902 adjacent a proximal end 900p and a pin portion 904 adjacent a distal end 900d of the module 900. The base 902 can extend along a longitudinal axis L. The pin portion 904 can include a shaft 908 coupled to a distal facing end of the base 902 and that shaft 908 can extend along the longitudinal axis L. The pin portion 904 can also include three pins or protrusions 906, 906′, 906″ extending outward from the shaft 908 along respective first transverse axes T1, T1′, T1″ that are rotationally offset from one another. Each of the protrusions 906, 906′, 906″ can be divided between adjacent ones of the segments 900a, 900b, 900c. A longitudinal channel 910 can extend along the longitudinal axis L between the proximal and distal ends 900p, 900d. Three transverse channels 912a, 912b, 912c can be formed through sidewalls the base 902 at positions rotationally offset from each of the protrusions 906a (e.g., between respective protrusions 906). As shown, the transverse channels 912a, 912b, 912c can extend along respective second transverse axes T2, T2′, T2″ that are rotationally offset from one another. Each of the transverse channels 912a, 912b, 912c can be contained within a single one of the segments 900a, 900b, 900c. While the module 900 is illustrated as having a generally cylindrical shape, other embodiments of the module can have a variety of other shapes, e.g., oval, square, rectangular, etc.

As shown in FIG. 9, each of the segments 900a, 900b, 900c can be approximately equally sized and they can each include a portion of the longitudinal channel 910. The longitudinal channel 910 can be formed through the shaft 908 and it can be dimensioned to receive a flexible member (e.g., flexible member 100) and provide an interference fit between the flexible member 100 and the module 900 when the flexible member 100 is received therein.

Similar to the module 200, the base 902 of one module 900 can be configured to couple to the pin portion 904 of another module 900 (not shown). As an example, the longitudinal channel 910 within the base 902 of one module can be dimensioned to receive the shaft 908 of another module. The protrusion 906 can also be dimensioned for receipt within respective ones of the transverse channels 912a, 912b, and 912c.

Further embodiments of the module can include a body having more than two ends. As an example, FIG. 10 illustrates a module 1000 similar to module 200, including a base 1002 and a pin portion 1004 coupled to a distal facing end of the base 1002. The pin portion 1004 can include a shaft 1008 coupled to the base 1002 and protrusion 1006 extending from the shaft 1008 along a first transverse axis T1 of the module 1000. However, in contrast to the module 200, the base 1002 can include a branched proximal end 1000p opposite the pin portion 1004. As illustrated in FIG. 10, the module 1000 is formed with a first branch 1002a and a second branch 1002b, each including a respective second transverse channel 1012a, 1012b extending along respective second transverse axes T2, T2′.

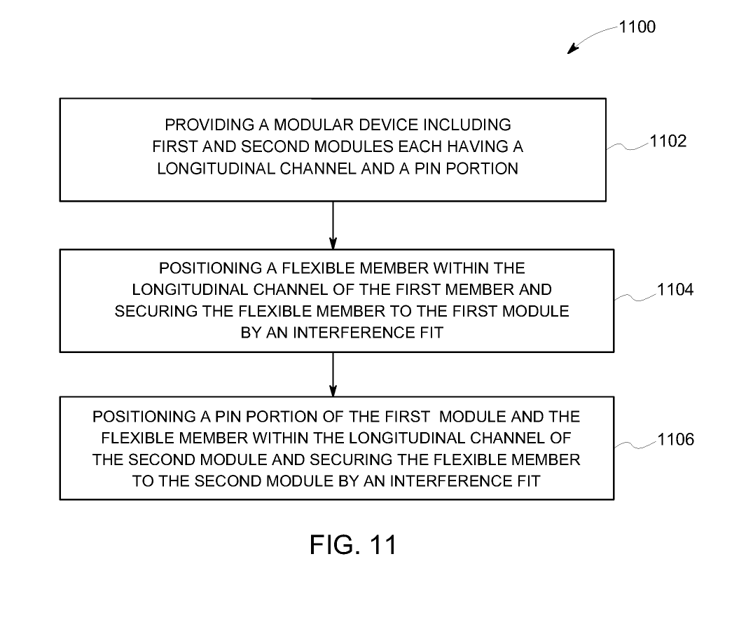

FIG. 11 is a flow diagram illustrating one exemplary embodiment of a method 1100 for protecting a flexible member. As shown, the method 1100 can include operations 1102-1106. In certain aspects, embodiments of the method 1100 can include greater or fewer operations than illustrated in FIG. 11 and can be performed in a different order than illustrated in FIG. 11.

In operation 1102, a modular device including first and second modules are provided. The at least two modules can be independently selected from any of modules 200, 500, 600, 800, 900, and 1000, as described above. As an example, each module can include a base, a pin portion, a longitudinal channel extending along a longitudinal axis and a transverse channel extending transverse to the longitudinal axis. The base can extend along the longitudinal axis. The pin portion can include a shaft extending along the longitudinal axis from a first end of the base and a protrusion extending along a first transverse axis with respect to the longitudinal axis. The longitudinal channel can extend through the base and the pin portion. The transverse channel can extend through at least a portion of the base and it can be rotationally offset from the first transverse axis (e.g., extending along a second transverse axis). Each module can be formed in two or more substantially equal segments and the longitudinal channel of each of the first and second modules can be dimensioned to couple to a flexible member positioned therein by an interference fit.

In operation 1104, the flexible member can be coupled to the first module. The flexible member can be positioned within the longitudinal channel of the first module (e.g., between the segments of the first module). As an example, at least a portion of the longitudinal channel (e.g., a distal portion) can be dimensioned to secure the first module to the flexible member by an interference fit.

In operation 1106, the first module and the flexible member can be coupled to a second module. The pin portion of the first module and the flexible member can each be positioned within the longitudinal channel of the second module. As an example, a first portion of the longitudinal channel of the second module (e.g., a proximal portion) can be dimensioned to receive the shaft of the pin portion of the first module. Each transverse channel of the second module can also be dimensioned to receive and seat a corresponding protrusion of the pin portion of the first module. The flexible member can be coupled to a second portion of the second module (e.g., a distal portion) to secure the second module to the flexible member by an interference fit.

In certain embodiments of the method 1100, the first and second modules can be rotated with respect to one another to permit bending of a flexible member coupled thereto. As an example, a hinge joint can be formed by receipt of the shaft of the first module within the longitudinal channel of the second module and the protrusion of the first module within the transverse channel of the second module. The first and second modules can rotate with respect to one another about the hinge joint to bend the flexible member. Embodiments of the method 1100 can also include limiting rotation of the first and second modules about the hinge joint within a predetermined angular range in order to inhibit bending of the flexible member to a bending radius less than a predetermined value.

Certain embodiments of the method 1100 can include rotating at least one of the first and second modules about the longitudinal axis. As an example, at least one of the first and second modules can be the module 800 including a pin portion and a base removeably and rotatably mated to one another by a rotation joint that rotates about the longitudinal axis, as discussed above with respect to FIGS. 8A-8C.

Exemplary technical effect of the methods, systems, and devices described herein includes, by way of non-limiting example, one or more of impact protection, torsional stiffness, tension relief, and bend restriction for flexible members. The modules can be snap fit around a flexible member to provide protection to the flexible member, while still allowing some movement of the flexible member, or portions thereof, as may be desired. Each module can be connected to an adjacent module in a chain-like manner, eliminating the need for additional fasteners, and reducing cost and complexity of the protection system. Any number of modules having any configuration can be mated in a desired arrangement.

Certain exemplary embodiments have been described to provide an overall understanding of the principles of the structure, function, manufacture, and use of the systems, devices, and methods disclosed herein. One or more examples of these embodiments are illustrated in the accompanying drawings. Those skilled in the art will understand that the systems, devices, and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention. Further, in the present disclosure, like-named components of the embodiments generally have similar features, and thus within a particular embodiment each feature of each like-named component is not necessarily fully elaborated upon.

One skilled in the art will appreciate further features and advantages of the invention based on the above-described embodiments. Accordingly, the present application is not to be limited by what has been particularly shown and described. All publications and references cited herein are expressly incorporated by reference in their entirety.

1. A modular device, comprising:
at least one module, each module having,
a base having at least a portion that extends along a longitudinal axis,
a pin portion including a shaft extending along the longitudinal axis from a first end of the base, and a protrusion extending along a first transverse axis,
a longitudinal channel extending along the longitudinal axis and through the base and the pin portion, and
a transverse channel extending through at least a portion of the base along a second transverse axis that is rotationally offset from the first transverse axis;
wherein each module is longitudinally divided in two or more 1 segments; and
wherein at least a portion of the longitudinal channel of each module is dimensioned to secure a flexible member positioned therein by an interference fit.

2. The modular device of claim 1, wherein the at least two segments comprise two segments separated along the longitudinal axis such that the protrusion has first and second protrusion segments and the base has first and second base segments.

3. The modular device of claim 1, wherein each module comprises three protrusions and wherein the at least two segments comprise three segments separated along the longitudinal axis such that each protrusion has a first and second protrusion segment and the base has first, second, and third base segments.

4. The modular device of claim 1, wherein the at least one module comprises a first module and a second module, and wherein the pin portion of the first module is coupled to the base of the second module.

5. The modular device of claim 4, wherein the shaft of the first module is dimensioned for receipt within the longitudinal channel of the second module and the protrusion of the first module is received within the transverse channel of the second module to couple the pin portion of the first module to the base of the second module and to provide a hinge joint.

6. The modular device of claim 5, wherein the first module and the second module are rotatable relative to one another about the hinge joint.

7. The modular device of claim 6, wherein the first end of the base of the first module is substantially convex and a second end of the base, opposite the first end, is substantially concave such that a gap is formed between the first module and the second module.

8. The modular device of claim 7, wherein the gap is dimensioned to limit rotation of the first and second modules relative to one another within a predetermined angular range.

9. The modular device of claim 4, wherein the base of at least one of the first and second modules includes a first portion that extends along the longitudinal axis and a second portion that extends transverse to the first longitudinal axis.

10. The modular device of claim 4, wherein the base of at least one of the first and second modules includes a flange adjacent to a second end of the base, opposite the pin portion.

11. The modular device of claim 4, wherein the pin portion and the base of at least one of the first and second modules are removeably mated to one another.

12. The modular device of claim 11, wherein the pin portion and the base of at least one of the first and second modules are rotatably mated to one another.

13. The modular device of claim 4, wherein the base of at least one of the first and second modules comprises:
a first longitudinally extending portion including the first end of the base coupled to the pin portion;
a second longitudinally extending portion including a second end of the base opposite the pin portion; and
a rotation joint rotationally coupling the first and second longitudinally extending portions of the base.

14. The modular device of claim 13, wherein the rotation joint further comprises:
a disk coupled to the first longitudinally extending base portion and extending outwards from the longitudinal channel; and
an annular chamber formed in the second base portion that is dimensioned to receive the disk.

15. The modular device of claim 4, wherein at least one of the first and second modules comprises the base including a branched second end opposite the pin portion.

16. A method of protecting a flexible member, comprising:
positioning a flexible member within a longitudinal channel extending through a pin portion and a base of a first module, wherein the longitudinal channel of the first module secures the flexible member to the first module by an interference fit; and
positioning the pin portion of the first module and the flexible member within a longitudinal channel extending through a pin portion and a base of a second module to couple the first module and the flexible member to the second module, wherein the longitudinal channel of the second module secures the flexible member to the second module by an interference fit.

17. The method of claim 16, wherein the first module includes a shaft that is received within the longitudinal channel of the second module and a protrusion that is received within a transverse channel of the second module to provide a hinge joint.

18. The method of claim 17, further comprising rotating the first and second modules about the hinge joint to bend the flexible member coupled to the first and second modules.

19. The method of claim 17, wherein the first and second modules limit rotation about the hinge joint within a predetermined angular range to inhibit bending of the flexible member coupled to the first and second modules to a bending radius less than a predetermined value.

20. The method of claim 16, wherein the pin portion and the base of at least one of the first and second modules are removeably and rotatably mated to one another by a rotation joint that rotates about the longitudinal axis.
